(19) United States
(12) Patent Application Publication
(10) Pub. No.: US 2013/0201917 A1
(43) Pub. Date: Aug. 8, 2013

(54) DYNAMIC INDICATION OF TRAFFIC TO PILOT (T/P) RATIOS

(71) Applicant: QUALCOMM Incorporated, San Diego, CA (US)

(72) Inventors: Aleksandar Damnjanovic, Del Mar, CA (US); Durga Prasad Malladi, San Diego, CA (US); Wanshi Chen, San Diego, CA (US); Peter Gaal, San Diego, CA (US)

(73) Assignee: QUALCOMM INCORPORATED, San Diego, CA (US)

(21) Appl. No.: 13/758,652

(22) Filed: Feb. 4, 2013

Related U.S. Application Data
(60) Provisional application No. 61/596,664, filed on Feb. 8, 2012.

(51) Int. Cl. H04W 24/02

(52) U.S. Cl. CPC H04W 24/02
USPC 370/328

(57) ABSTRACT

An method of wireless communication dynamically indicates traffic to pilot ratio (T/P) values in heterogeneous networks. Subframes are categorized into groups that do not overlap. A traffic to pilot ratio (T/P) indicator is received and the a T/P value for a group of subframes is determined based at least in part on the received T/P indicator.

### CROSS-REFERENCE TO RELATED APPLICATION

This application claims the benefit under 35 U.S.C. §119(e) to U.S. Provisional Patent Application No. 61/596,664 entitled “DYNAMIC INDICATION OF TRAFFIC TO PILOT (T/P) RATIOS,” filed on Feb. 8, 2012, the disclosure of which is expressly incorporated by reference herein in its entirety.

### BACKGROUND

1. Field

The present disclosure relates generally to communication systems, and more particularly, to dynamically indicate traffic to pilot (T/P) ratio values for a complementary set of subframes.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

An aspect of the present disclosure is directed to dynamically indicating traffic to pilot ratio (T/P) values in heterogeneous networks. Subframes are categorized into groups that do not overlap. A traffic to pilot ratio (T/P) indicator is received and the a T/P value for a group of subframes is determined based at least in part on the received T/P indicator.

According to another aspect of the present disclosure, a method of wireless communication includes determining a first group of subframes. The method also includes determining a second group of subframes that does not overlap the first group of subframes. The method further includes receiving at least one signal including a T/P indicator. Additionally, the method includes determining a T/P value for the second group based at least in part on the at least one signal.

According to yet another aspect of the present disclosure, a method of wireless communication includes indicating a configuration for a first group of subframes. The method also includes transmitting at least one T/P value. The method further includes transmitting at least one signal to associate the T/P value with at least one group of subframes.

According to still yet another aspect of the present disclosure, an apparatus for wireless communication includes means for determining a first group of subframes. The apparatus also includes means for determining a second group of subframes that does not overlap the first group of subframes. The apparatus further includes means for receiving at least one signal including a T/P indicator. Additionally, the apparatus includes means for determining a T/P value for the second group based at least in part on the at least one signal.

According to another aspect of the present disclosure, an apparatus for wireless communication includes means for indicating a configuration for a first group of subframes. The apparatus also includes means for transmitting at least one T/P value. The apparatus further includes means for transmitting at least one signal to associate the T/P value with at least one group of subframes.

According to yet another aspect of the present disclosure, a computer program product for wireless communications includes a non-transitory computer-readable medium having program code recorded thereon. The program code includes program code to determine a first group of subframes. The program code also includes program code to determine a second group of subframes that does not overlap the first group of subframes. The program code further includes program code to receive at least one signal including a T/P indicator. Additionally, the program code includes program code to determine a T/P value for the second group based at least in part on the at least one signal.

According to still yet another aspect of the present disclosure, a computer program product for wireless communications includes a non-transitory computer-readable medium having program code recorded thereon. The program code includes program code to indicate a configuration for a first group of subframes. The program code also includes program code to transmit at least one T/P value. The program code further includes program code to transmit at least one signal to associate the T/P value with at least one group of subframes.

According to another aspect of the present disclosure, an apparatus for wireless communications includes a memory and a processor(s) coupled to the memory. The processor is configured to determine a first group of subframes. The processor is also configured to determine a second group of subframes that does not overlap the first group of subframes. The processor is further configured to receive at least one signal including a T/P indicator. Additionally, the processor is configured to determine a T/P value for the second group based at least in part on the at least one signal.

According to another aspect of the present disclosure, an apparatus for wireless communications includes a memory and a processor(s) coupled to the memory. The processor is configured to indicate a configuration for a first group of subframes. The processor is also configured to transmit at least one T/P value. The processor is further configured to transmit at least one signal to associate the T/P value with at least one group of subframes.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a downlink frame structure in LTE.

FIG. 4 is a diagram illustrating an example of a radio protocol architecture for the user and control plane.

FIG. 5 is a diagram illustrating an example of an evolved Node B and user equipment in an access network.

FIG. 6 is a diagram illustrating a range expanded cellular region in a heterogeneous network.

FIG. 7 is a block diagram conceptually illustrating adaptive resource partitioning in a heterogeneous network according to one aspect of the disclosure.

FIGS. 8A and 8B are flow charts for a method of wireless communication.

FIG. 9 is a conceptual data flow diagram illustrating the data flow between different modules/means/components in an exemplary apparatus.

FIG. 10 is a block diagram illustrating different modules/means/components in an exemplary apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

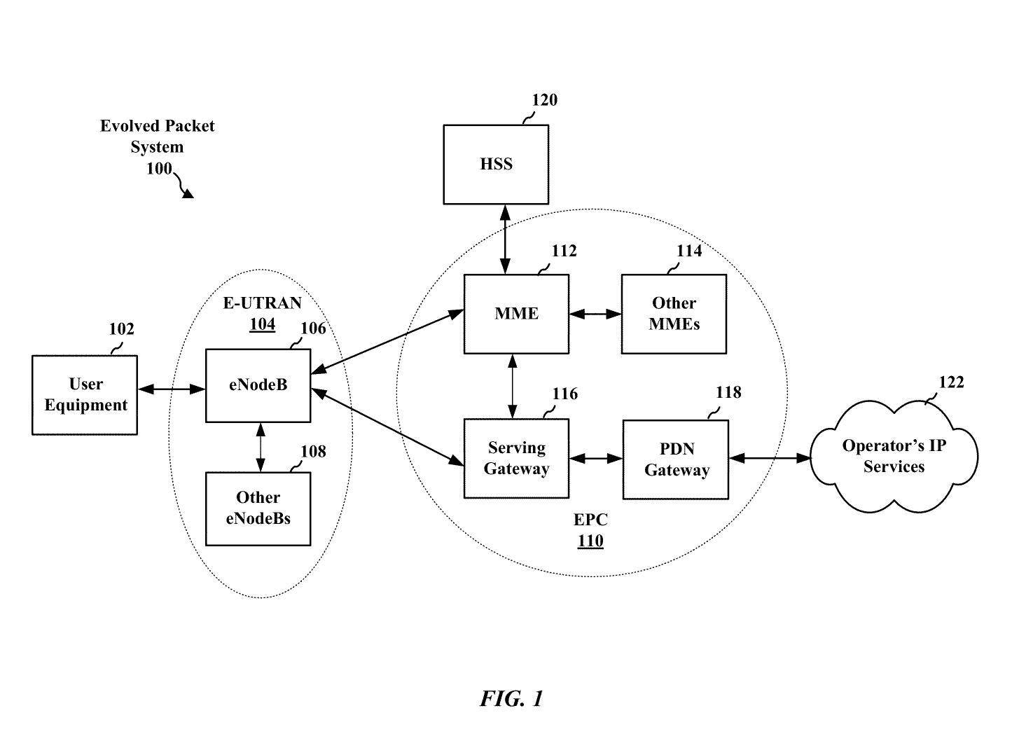

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS 100 can interconnect with other access networks, but for simplicity those entities/interfaces are not shown. As shown, the EPS 100 provides packet-switched services, however, as those skilled in the art will readily appreciate, the various concepts presented throughout this disclosure may be extended to networks providing circuit-switched services.

The E-UTRAN 104 includes the evolved Node B (eNodeB) 106 and other eNodeBs 108. The eNodeB 106 provides user and control plane protocol terminations toward the UE 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

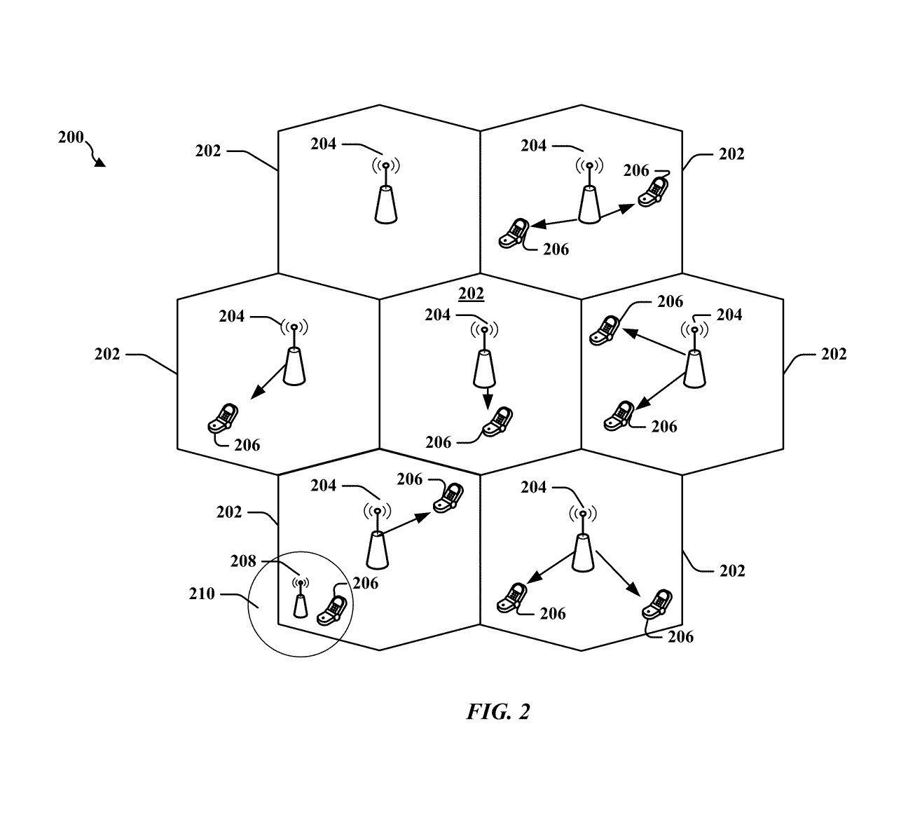

FIG. 2 is a diagram illustrating an example of an access network 200 in an LTE network architecture. In this example, the access network 200 is divided into a number of cellular regions (cells) 202. One or more lower power class eNodeBs 208 may have cellular regions 210 that overlap with one or more of the cells 202. A lower power class eNodeB 208 may be a remote radio head (RRH), a femto cell (e.g., home eNodeB (HeNB)), a pico cell, or a micro cell. The macro eNodeBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNodeBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNodeBs 204 may have multiple antennas supporting MIMO technology. The use of MIMO technology enables the eNodeBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNodeB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

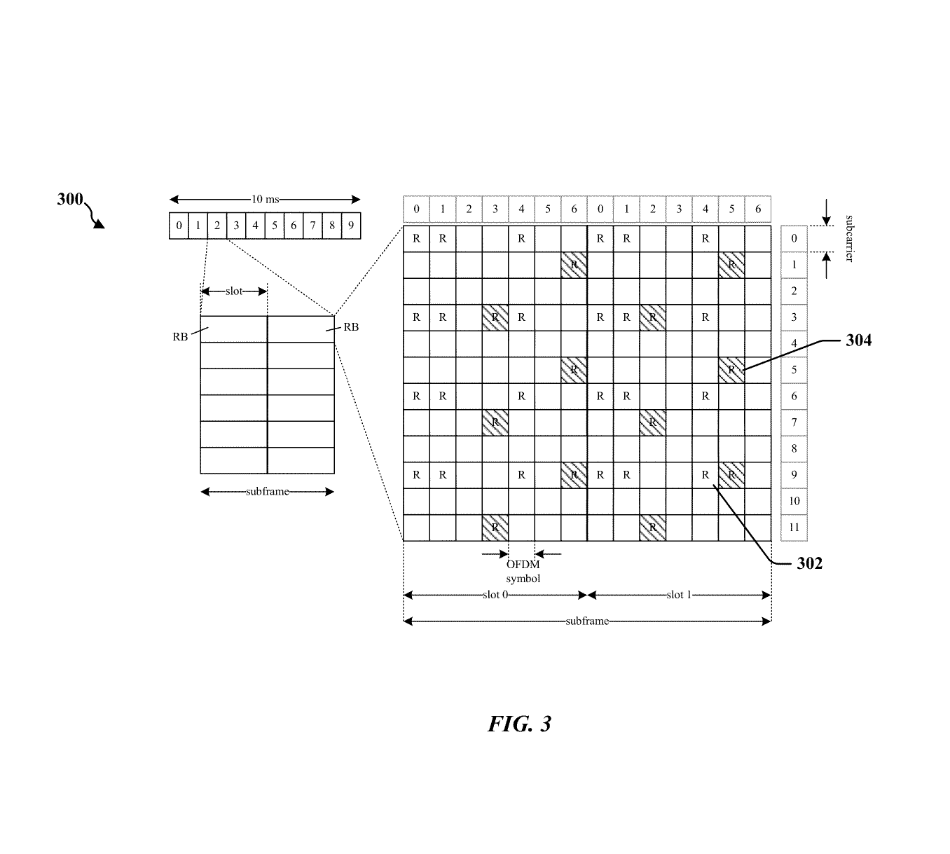

FIG. 3 is a diagram 300 illustrating an example of a DL frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

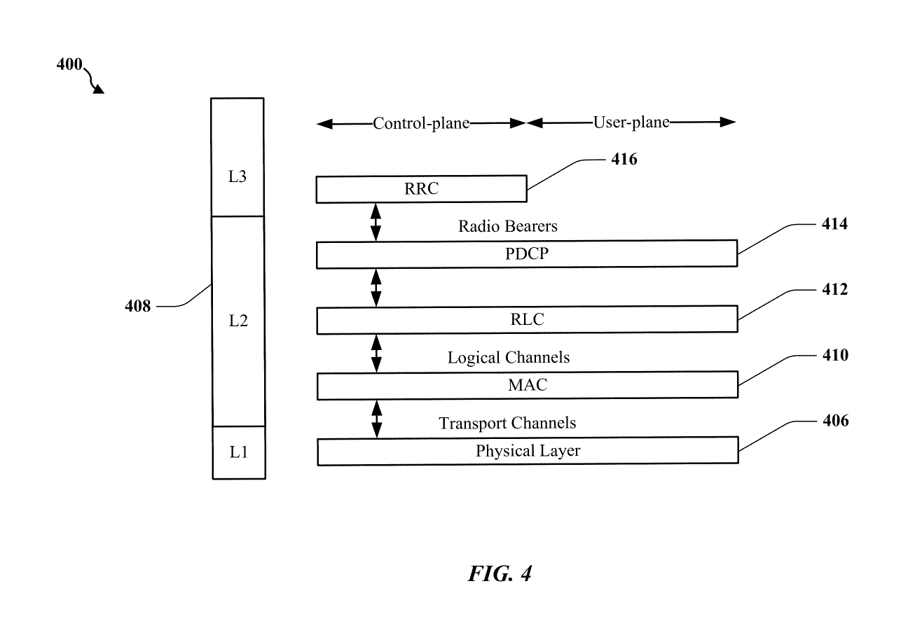

FIG. 4 is a diagram 400 illustrating an example of a radio protocol architecture for the user and control planes in LTE. The radio protocol architecture for the UE and the eNodeB is shown with three layers: Layer 1, Layer 2, and Layer 3. Layer 1 (L1 layer) is the lowest layer and implements various physical layer signal processing functions. The L1 layer will be referred to herein as the physical layer 406. Layer 2 (L2 layer) 408 is above the physical layer 406 and is responsible for the link between the UE and eNodeB over the physical layer 406.

In the user plane, the L2 layer 408 includes a media access control (MAC) sublayer 410, a radio link control (RLC) sublayer 412, and a packet data convergence protocol (PDCP) 414 sublayer, which are terminated at the eNodeB on the network side. Although not shown, the UE may have several upper layers above the L2 layer 408 including a network layer (e.g., IP layer) that is terminated at the PDN gateway 118 on the network side, and an application layer that is terminated at the other end of the connection (e.g., far end UE, server, etc.).

The PDCP sublayer 414 provides multiplexing between different radio bearers and logical channels. The PDCP sublayer 414 also provides header compression for upper layer data packets to reduce radio transmission overhead, security by ciphering the data packets, and handover support for UEs between eNodeBs. The RLC sublayer 412 provides segmentation and reassembly of upper layer data packets, retransmission of lost data packets, and reordering of data packets to compensate for out-of-order reception due to hybrid automatic repeat request (HARQ). The MAC sublayer 410 provides multiplexing between logical and transport channels. The MAC sublayer 410 is also responsible for allocating the various radio resources (e.g., resource blocks) in one cell among the UEs. The MAC sublayer 410 is also responsible for HARQ operations.

In the control plane, the radio protocol architecture for the UE and eNodeB is substantially the same for the physical layer 406 and the L2 layer 408 with the exception that there is no header compression function for the control plane. The control plane also includes a radio resource control (RRC) sublayer 416 in Layer 3 (L3 layer). The RRC sublayer 416 is responsible for obtaining radio resources (i.e., radio bearers) and for configuring the lower layers using RRC signaling between the eNodeB and the UE.

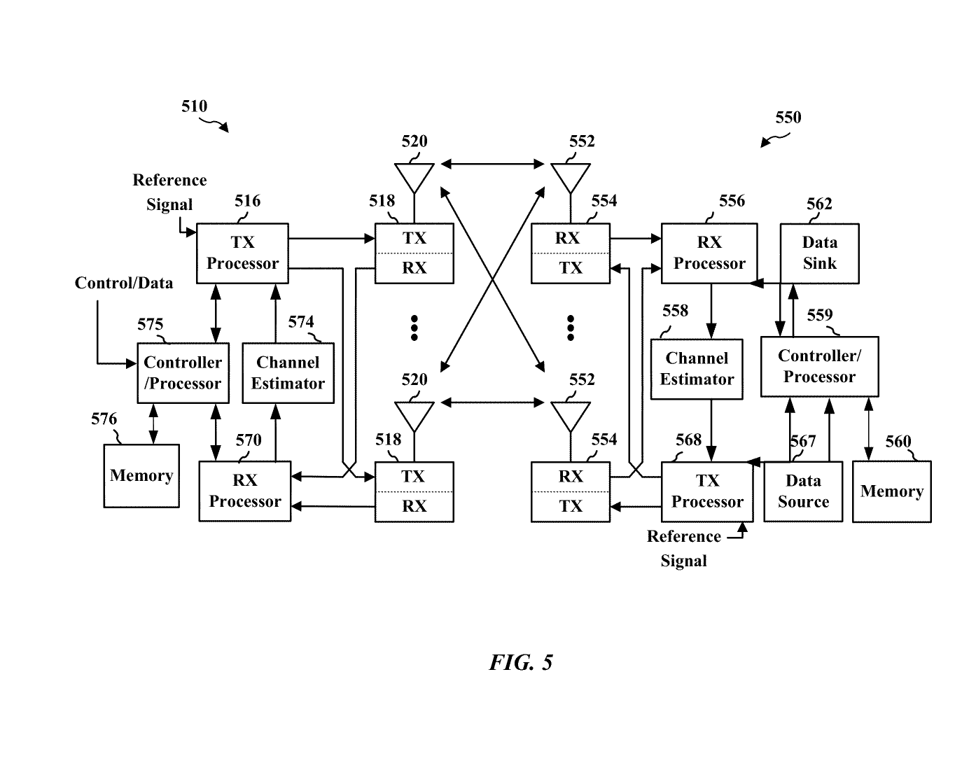

FIG. 5 is a block diagram of an eNodeB 510 in communication with a UE 550 in an access network. In the DL, upper layer packets from the core network are provided to a controller/processor 575. The controller/processor 575 implements the functionality of the L2 layer. In the DL, the controller/processor 575 provides header compression, ciphering, packet segmentation and reordering, multiplexing between logical and transport channels, and radio resource allocations to the UE 550 based on various priority metrics. The controller/processor 575 is also responsible for HARQ operations, retransmission of lost packets, and signaling to the UE 550.

The TX processor 516 implements various signal processing functions for the L1 layer (i.e., physical layer). The signal processing functions includes coding and interleaving to facilitate forward error correction (FEC) at the UE 550 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 574 may be used to determine the coding and modulation scheme, as well as for spatial processing. The channel estimate may be derived from a reference signal and/or channel condition feedback transmitted by the UE 550. Each spatial stream is then provided to a different antenna 520 via a separate transmitter 518TX. Each transmitter 518TX modulates an RF carrier with a respective spatial stream for transmission.

At the UE 550, each receiver 554RX receives a signal through its respective antenna 552. Each receiver 554RX recovers information modulated onto an RF carrier and provides the information to the receiver (RX) processor 556. The RX processor 556 implements various signal processing functions of the L1 layer. The RX processor 556 performs spatial processing on the information to recover any spatial streams destined for the UE 550. If multiple spatial streams are destined for the UE 550, they may be combined by the RX processor 556 into a single OFDM symbol stream. The RX processor 556 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNodeB 510. These soft decisions may be based on channel estimates computed by the channel estimator 558. The soft decisions are then decoded and deinterleaved to recover the data and control signals that were originally transmitted by the eNodeB 510 on the physical channel. The data and control signals are then provided to the controller/processor 559.

The controller/processor 559 implements the L2 layer. The controller/processor 559 can be associated with a memory 560 that stores program codes and data. The memory 560 may be referred to as a computer-readable medium. In the UL, the controller/processor 559 provides demultiplexing between transport and logical channels, packet reassembly, deciphering, header decompression, control signal processing to recover upper layer packets from the core network. The upper layer packets are then provided to a data sink 562, which represents all the protocol layers above the L2 layer. Various control signals may also be provided to the data sink 562 for L3 processing. The controller/processor 559 is also responsible for error detection using an acknowledgement (ACK) and/or negative acknowledgement (NACK) protocol to support HARQ operations.

In the UL, a data source 567 is used to provide upper layer packets to the controller/processor 559. The data source 567 represents all protocol layers above the L2 layer. Similar to the functionality described in connection with the DL transmission by the eNodeB 510, the controller/processor 559 implements the L2 layer for the user plane and the control plane by providing header compression, ciphering, packet segmentation and reordering, and multiplexing between logical and transport channels based on radio resource allocations by the eNodeB 510. The controller/processor 559 is also responsible for HARQ operations, retransmission of lost packets, and signaling to the eNodeB 510.

Channel estimates derived by a channel estimator 558 from a reference signal or feedback transmitted by the eNodeB 510 may be used by the TX processor 568 to select the appropriate coding and modulation schemes, and to facilitate spatial processing. The spatial streams generated by the TX processor 568 are provided to different antenna 552 via separate transmitters 554TX. Each transmitter 554TX modulates an RF carrier with a respective spatial stream for transmission.

The UL transmission is processed at the eNodeB 510 in a manner similar to that described in connection with the receiver function at the UE 550. Each receiver 518RX receives a signal through its respective antenna 520. Each receiver 518RX recovers information modulated onto an RF carrier and provides the information to a RX processor 570. The RX processor 570 may implement the L1 layer.

The controller/processor 575 implements the L2 layer. The controller/processor 575 can be associated with a memory 576 that stores program codes and data. The memory 576 may be referred to as a computer-readable medium. In the UL, the controller/processor 575 provides demultiplexing between transport and logical channels, packet reassembly, deciphering, header decompression, control signal processing to recover upper layer packets from the UE 550. Upper layer packets from the controller/processor 575 may be provided to the core network. The controller/processor 575 is also responsible for error detection using an ACK and/or NACK protocol to support HARQ operations.

Wireless networks may have eNodeBs of different power classes. For example, three power classes may be defined, in decreasing power class, as macro eNodeBs, pico eNodeBs, and femto eNodeBs. Networks featuring such different power class eNodeBs may be referred to as heterogeneous networks. When macro eNodeBs, pico eNodeBs, and femto eNodeBs are in a co-channel deployment, the power spectral density (PSD) of the macro eNodeB (aggressor eNodeB) may be larger than the PSD of the pico eNodeB and the femto eNodeB (victim eNodeBs) creating large amounts of interference with the pico eNodeB and the femto eNodeB. Protected subframes may be used to reduce or minimize interference with the pico eNodeBs and femto eNodeBs. That is, a protected subframe may be scheduled for the victim eNodeB to correspond with a prohibited subframe on the aggressor eNodeB.

A heterogeneous wireless network uses a diverse set of eNodeBs (e.g., macro eNodeBs, RRHs, pico eNodeBs, femto eNodeBs, and relays) to improve the spectral efficiency of the system per unit area. The macro eNodeBs are usually carefully planned and placed by the provider of the wireless network. The macro eNodeBs generally transmit at high power levels (e.g., 5 W-40 W). RRHs, pico eNodeBs, and relays, which generally transmit at substantially lower power levels (e.g., 100 mW-2 W), may be deployed in a relatively unplanned manner to eliminate coverage holes in the coverage area provided by the macro eNodeBs and improve capacity in the hot spots. The femto eNodeBs, which are typically deployed independently from the wireless network may, nonetheless, be incorporated into the coverage area of the wireless network either as a potential access point to the wireless network, if authorized by their administrator(s), or at least as an active and aware eNodeB that may communicate with the other eNodeBs of the wireless network to perform resource coordination and coordination of interference management. The femto eNodeBs typically also transmit at substantially lower power levels (e.g., 100 mW-2 W) than the macro eNodeBs.

In operation of a heterogeneous network, such as the EPS 100, each UE is usually served by the eNodeB 106 with the better signal quality, while the unwanted signals received from the other eNodeBs 108 are treated as interference. While such operational principals can lead to significantly sub-optimal performance, gains in network performance are realized in the EPS 100 by using intelligent resource coordination among the eNodeBs 106, better server selection strategies, and more advanced techniques for efficient interference management.

A pico eNodeB is characterized by a substantially lower transmit power when compared with a macro eNodeB. A pico eNodeB will also usually be placed around a network in an ad hoc manner. Because of this unplanned deployment, wireless networks with pico eNodeB placements can be expected to have large areas with low signal to interference conditions, which can make for a more challenging RF environment for control channel transmissions to UEs on the edge of a coverage area or cell (a “cell-edge” UE). Moreover, the potentially large disparity (e.g., approximately 20 dB) between the transmit power levels of the macro eNodeBs and the pico eNodeB implies that, in a mixed deployment, the downlink coverage area of the pico eNodeB will be much smaller than that of the macro eNodeBs.

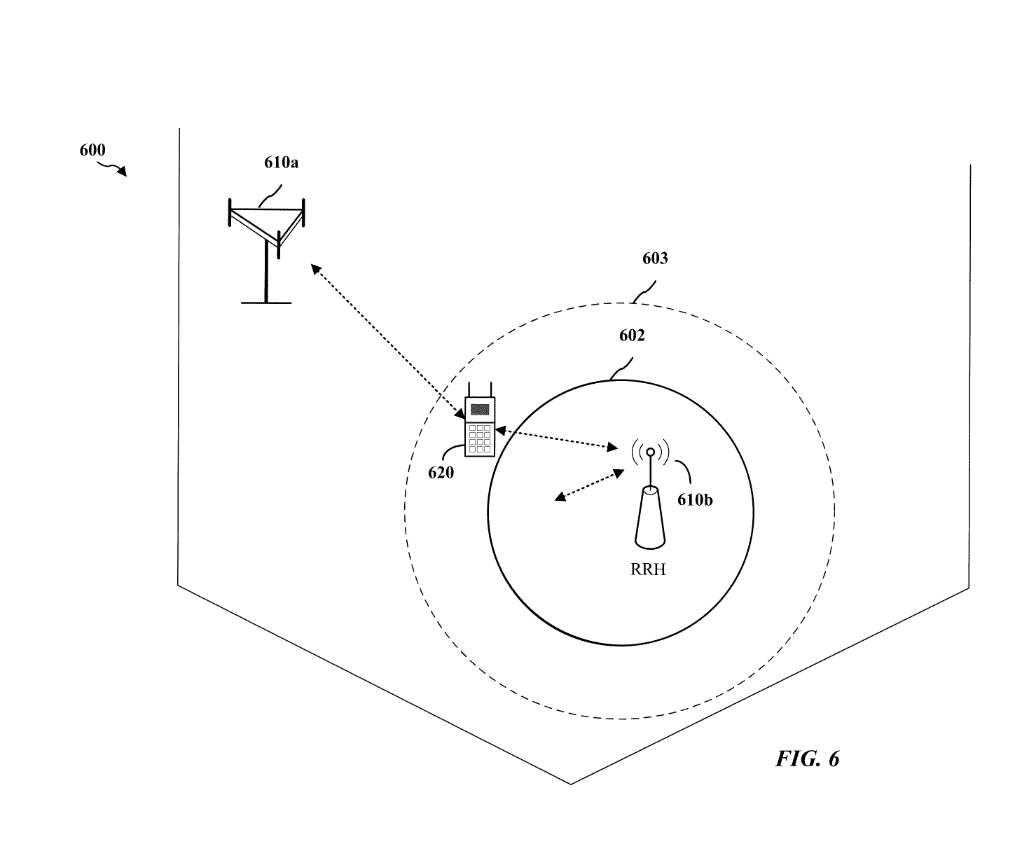

FIG. 6 is a diagram 600 illustrating a range expanded cellular region in a heterogeneous network. A lower power class eNodeB such as the RRH 610b may have a range expanded cellular region 603 that is expanded from the cellular region 602 through enhanced inter-cell interference coordination between the RRH 610b and the macro eNodeB 610a and through interference cancelation performed by the UE 620. In enhanced inter-cell interference coordination, the RRH 610b receives information from the macro eNodeB 610a regarding an interference condition of the UE 620. The information allows the RRH 610b to serve the UE 620 in the range expanded cellular region 603 and to accept a handoff of the UE 620 from the macro eNodeB 610a as the UE 620 enters the range expanded cellular region 603.

In a heterogeneous network with range extension, in order for UEs to obtain service from the lower-powered eNodeBs, in the presence of the stronger downlink signals transmitted from the higher-powered eNodeBs, the pico eNodeB engages in control channel and data channel interference coordination with the dominant interfering ones of the macro. Many different techniques for interference coordination may be employed to manage interference. For example, inter-cell interference coordination (ICIC) may be used to reduce interference from cells in co-channel deployment. One ICIC mechanism is adaptive resource partitioning. Adaptive resource partitioning assigns subframes to certain eNodeBs. In subframes assigned to a first eNodeB, neighbor eNodeBs do not transmit. Thus, interference experienced by a UE served by the first eNodeB is reduced. Subframe assignment may be performed on both the uplink and downlink channels.

For example, subframes may be allocated between three classes of subframes: protected subframes (U subframes or full power), prohibited subframes (N subframes or low power), and common subframes (C subframes). Protected subframes are assigned to a first eNodeB for use by the first eNodeB while the second eNodeB is limited to low power transmission on these subframes. Protected subframes may also be referred to as “clean” subframes based on the lower interference from neighboring eNodeBs. Prohibited subframes are subframes assigned to a neighbor eNodeB, and the first eNodeB is prohibited from transmitting data at full power during the prohibited subframes. For example, a prohibited subframe of the first eNodeB may correspond to a protected subframe of a second interfering eNodeB. Thus, the first eNodeB is the only eNodeB transmitting data at full power during the first eNodeB's protected subframe. Common subframes may be used for data transmission by multiple eNodeBs. Common subframes may also be referred to as “unclean” subframes because of the possibility of interference from other eNodeBs.

At least one protected subframe is statically assigned per period. In some cases only one protected subframe is statically assigned. For example, if a period is 8 milliseconds, one protected subframe may be statically assigned to an eNodeB during every 8 milliseconds. Other subframes may be dynamically allocated.

Adaptive resource partitioning information (ARPI) allows the non-statically assigned subframes to be dynamically allocated. These subframes may be referred to as complementary subframes. Any of protected, prohibited, or common subframes may be dynamically allocated (AU, AN, AC subframes, respectively). The dynamic assignments may change quickly, such as, for example, every one hundred milliseconds or less.

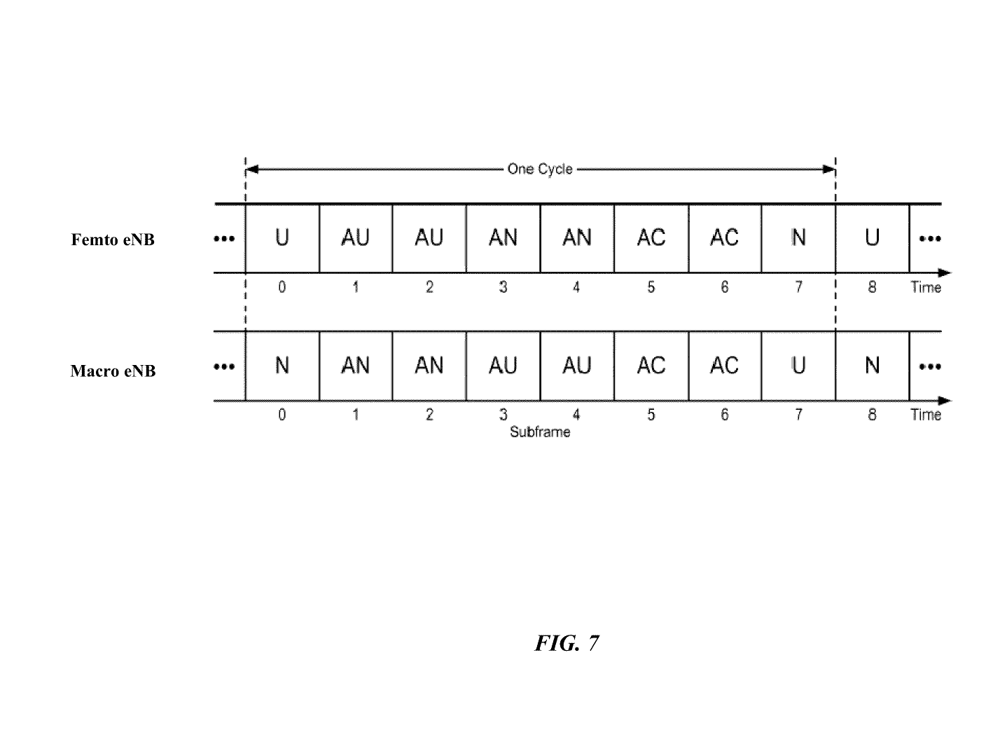

FIG. 7 is a block diagram illustrating TDM partitioning in a heterogeneous network according to one aspect of the disclosure. A first row of blocks illustrate subframe assignments for a femto eNodeB, and a second row of blocks illustrate subframe assignments for a macro eNodeB. Each of the eNodeBs has a static protected subframe during which the other eNodeB has a static prohibited subframe. For example, the femto eNodeB has a protected subframe (U subframe) in subframe 0 corresponding to a prohibited subframe (N subframe) in subframe 0. Likewise, the macro eNodeB has a protected subframe (U subframe) in subframe 7 corresponding to a prohibited subframe (N subframe) in subframe 7. Subframes 1-6 are dynamically assigned as either protected subframes (AU), prohibited subframes (AN), or common subframes (AC). The dynamically assigned subframes (AU/AN/AC) are referred to herein collectively as “X” subframes. During the dynamically assigned common subframes (AC) in subframes 5 and 6, both the femto eNodeB and the macro eNodeB may transmit data.

Protected subframes (such as U/AU subframes) have reduced interference and a high channel quality because aggressor eNodeBs are prohibited from transmitting. Prohibited subframes (such as N/AN subframes) have no data transmission to allow victim eNodeBs to transmit data with low interference levels. Common subframes (such as C/AC subframes) have a channel quality dependent on the number of neighbor eNodeBs transmitting data. For example, if neighbor eNodeBs are transmitting data on the common subframes, the channel quality of the common subframes may be lower than the protected subframes. Channel quality on common subframes may also be lower for cell range expansion area (CRE) UEs strongly affected by aggressor eNodeBs. A CRE UE may belong to a first eNodeB but also be located in the coverage area of a second eNodeB. For example, a UE communicating with a macro eNodeB that is near the range limit of a femto eNodeB coverage is a CRE UE.

In LTE heterogeneous networks, the common reference signal (CRS) is transmitted with full power. The physical data shared channel (PDSCH) is transmitted with reduced power on lower power subframes. The lower power subframes may be referred to as almost blank subframes (ABS). The PDSCH is transmitted with full power on non-ABS subframes. In some cases, inter-cell interference coordination (ICIC) may be enabled with the configuration of a traffic to pilot (T/P) ratio.

The traffic to pilot ratio indicates whether there is traffic from an interfering cell in a particular resource element group and thus indicates whether the UE should perform interference cancellation for that resource element group. If the value of the traffic to pilot ratio is estimated to be close to zero, then there is no traffic on the interfering cell, and interference cancellation is not performed. If the value of the traffic to pilot ratio is larger than a certain threshold, then an interfering cell is transmitting in that region and interference cancellation is desirable.

In one configuration, a first group of subframes are configured using a first traffic to pilot ratio (T/P) value for both channel signal information (CSI) feedback and demodulation. (e.g., subset 1). Furthermore, a second group of subframes are configured to use a second T/P value for both CSI feedback and demodulation (e.g., subset 2). The first T/P value is different from the second T/P value. Subframes that are not included in the first group or second group of subframes are scheduled with one of the two T/P values. The subframes that are not included in the first group or second group of subframes may be referred to as a complementary set of subframes.

The complementary set of subframes are non-overlapping with the first and second subset of subframes. Furthermore, the total number of subframes (e.g., complementary, first subset, and second subset) may be less than or equal to the total number of available subframes. In one configuration, the T/P value may be blindly estimated. For example, the complementary set may be assigned a T/P value based on an average or weighted average of the two T/P values. Alternatively, the T/P value of the complementary set may be assigned based on a statistical analysis of the two T/P values. In another configuration, a control channel, such as the physical data control channel (PDCCH), may be used to implicitly indicate the T/P value without increasing the payload of any format.

In one aspect of the present disclosure, for the implicit indication of the T/P value, the control channel may include transmit power control (TPC) bits that specify the T/P value for the complementary set of subframes. The remaining TPC bits (i.e., the bits not used to indicate the T/P value) are used for power control. Conventionally, when two bits are used to indicate the TPC value, the power correction is −1, 0, +1 and 3 dB. However, in one configuration, one TPC bit is used to indicate the T/P value. Thus, the one TPC bit used for the power correction may correspond to a reduced set of power correction values (e.g., −1, +1 dB), while the remaining bit is used to identify one of the two T/P values for the complimentary subframes.

In another configuration, the control channel may include a HARQ process ID bit to indicate the T/P value for the complementary set of subframes. The remaining bits for the HARQ process ID may be used by other subframes for a conventional HARQ process. Each HARQ process is given a unique ID (i.e., the HARQ process ID). Further, the HARQ process ID can be designated via control channel signaling (e.g., PDCCH). In one configuration, one HARQ process ID bit is used to indicate the T/P value. The remaining two bits (for FDD) or three bits (for TDD) are used to indicate the process ID. In this configuration, the eNodeB uses up to four (for FDD) or eight (for TDD) HARQ processes for the complementary set of subframes.

In another configuration, the available process IDs can be used for quadrature phase-shift keying (QPSK), non-MIMO transmissions. In this configuration, the UE first determines the modulation and coding scheme (MCS) value. After determining the MCS value, a T/P is not conveyed to the UE and all HARQ processes can be used if the MCS corresponds to QPSK transmission. If the MCS value corresponds to 16 QAM or 64 QAM transmission then one HARQ process ID bit is used to indicate the T/P value. The single HARQ process ID bit is used as a binary indicator to identify one of the two T/P values. The remaining two bits (for FDD) or three bits (for TDD) are used to indicate the process ID.

According to yet another configuration, a cell radio network temporary identifier (CRNTI) included in the control channel may be used to indicate the T/P value. The CRNTI is the radio network temporary identifier (RNTI) used by a given UE while it is in a particular cell. In one aspect of the present disclosure, the eNodeB allocates two CRNTIs to a UE. One CRNTI indicates a first T/P value and the other CRNTI indicates the second T/P value.

In still yet another configuration, the control channel element (CCE) search space is used to indicate the T/P value. The CCE is a set of resource elements (RE) to which part or all of a PDCCH message can be mapped. In one configuration, the resource elements of a CCE search space are divided into two groups. If the UE is directed to a first CCE search space, a first T/P value is indicated. If directed to a second CCE search space, a second T/P value is indicated. In one configuration, more than two search spaces or CRNTIs can be used to indicate more than two T/P values.

In yet another configuration, a broadcast bitmap of the control channel may be used to indicate the T/P value. In particular, a downlink control information (DCI) format conveys T/P values for each subframe. The DCI format is a 40-bit bitmap and is broadcast to all UEs via a common RNTI (TP-RNTI).

In another configuration, a radio resource control (RRC) signal may be used to indicate a new T/P value for the complementary set of subframes. That is, while various configurations may be specified to identify and select one of the known T/P values via single bit indicators, in this configuration, a unique T/P value for the complimentary set may be transmitted to one or more UEs via an RRC signal. The T/P value may be indicated in the RRC signal as a numeric or indexed value. Alternatively, the RRC may use an indicator to associate one of the two T/P value with the complimentary set of subframes.

In yet another configuration, a UE derives the T/P value based on a received modulation and coding scheme (MCS) value. For example, if the received MCS indicates 16 QAM, 64 QAM, or multiple input multiple output (MIMO) with any modulation order, then an MCS with an even value indicates a first T/P value. Further, a MCS with an odd value indicates a second T/P value (where the second T/P value is different from the first T/P value). In one configuration, the MCS for the first transport block is used for this deriving the T/P value. Additionally, if the MCS indicates a QPSK and no MIMO, then the MCS is the new MCS value and T/P is not conveyed to the UE.

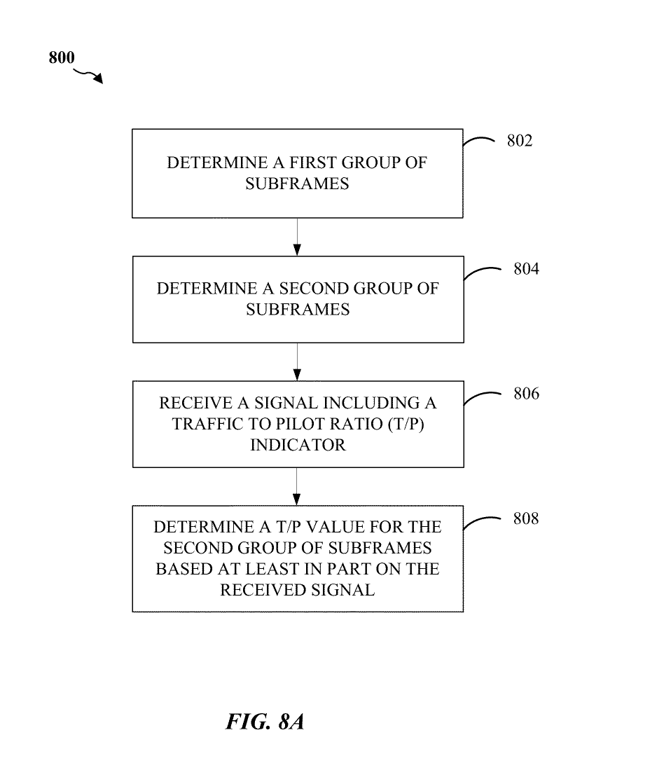

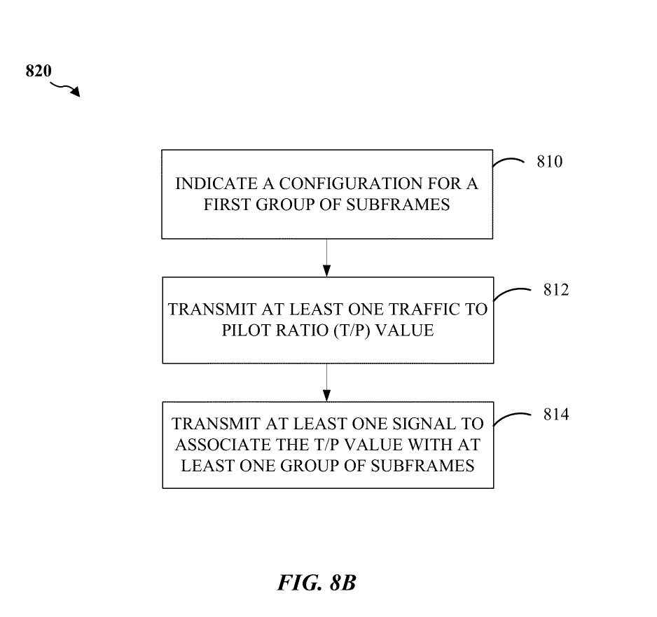

FIG. 8A is a flow chart 800 of a method for of wireless communication that may be performed by a UE.

At block 802, the UE determines a first group of subframes. The first group of subframes includes one or more subsets of subframes. For example, the first group of subframes may include a first subset of subframes and a second subset of subframes.

At block 804, the UE determines a second group of subframes. The second group of subframes does not overlap the first group of subframes. Therefore, the second group of subframe is complimentary or orthogonal to the first group of subframes.

At block 806, the UE receives a signal(s) that includes a traffic to pilot ratio (T/P) indicator. In one configuration, the signal(s) indicate a first T/P value for the first subset of subframes and a second T/P value for the second subset of subframes.

Finally, at block 808, the UE determines a T/P value for the second group of subframes based at least in part on the received signal(s). That is, in one configuration, the T/P value for the second group of subframes is determined based at least in part on the first T/P value and the second T/P value. For example, the T/P value associated with the second group of subframes may be provided via implicit signaling or association with a transmission property from the serving eNB, explicit signaling from the serving eNB, or by blind decoding by the UE. In another configuration, the T/P value for the second group of subframes may be based on an indicator in the received signal. The received signal may be a control channel, such as the PDCCH.

FIG. 8B is a flow chart 820 of a method for wireless communication that may be performed by an eNodeB.

At block 810, the eNodeB indicates a configuration for a first group of subframes. In one configuration, the group subframes includes one or more subsets of subframes. For example, the first group of subframes may include a first subset of subframes and a second subset of subframes.

At block 812, the eNodeB transmits at least one traffic to pilot ratio (T/P) value. In one configuration, the eNodeB transmits a signal to indicate a first T/P value for the first subset of subframes and a second T/P value for the second subset of subframes. In another configuration, the eNodeB transmits a signal to implicitly indicate the T/P value for a second group of subframes that do not overlap the first group of subframes.

Finally, at block 814 the eNodeB transmits a signal(s) to associate the T/P value with at least one group of subframes. In one configuration, the signal may associate the T/P value(s) with the first subset of subframes and the second subset of subframes. In another configuration, the signal may associate the T/P value with the second group of subframes.

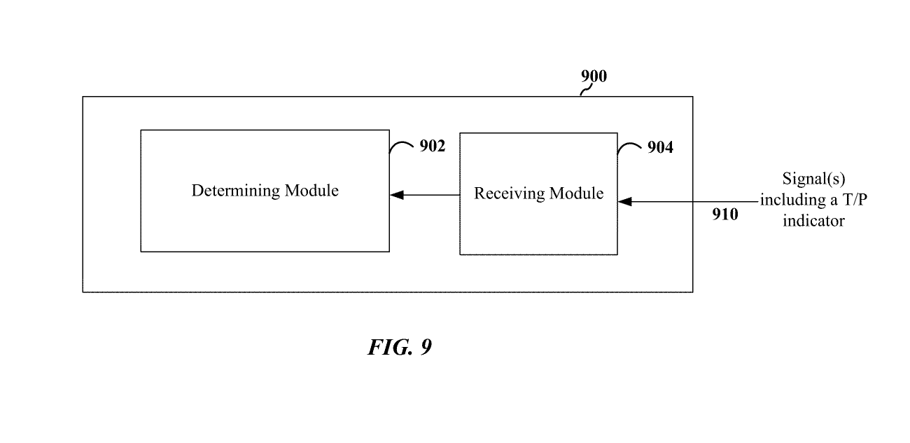

FIG. 9 is a conceptual data flow diagram illustrating the data flow between different modules/means/components in an exemplary apparatus 900. The apparatus 900 includes a determining module 902 that determines a first group of subframes and also determines a second group of subframes. Although shown as one module in FIG. 9, the determining module 902 may have separate modules for detecting the first group of subframes and the second group of subframes. The apparatus 900 also includes a receiving module 904 that receives a signal(s) 910 that includes a T/P indicator. In one configuration, the signal(s) 910 indicate a first T/P value for the first subset of subframes and a second T/P value for the second subset of subframes. The determining module 902 may also determine the first group of subframes and the second group of subframes via a signal 910 received at the receiving module.

In one configuration, the determining module 902 may also determine a T/P value for the second group of subframes based at least in part on the received signal(s) 910. The apparatus may include additional modules that perform each of the steps of the algorithm in the aforementioned flow charts FIG. 8A. As such, each step in the aforementioned flow charts FIG. 8A may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

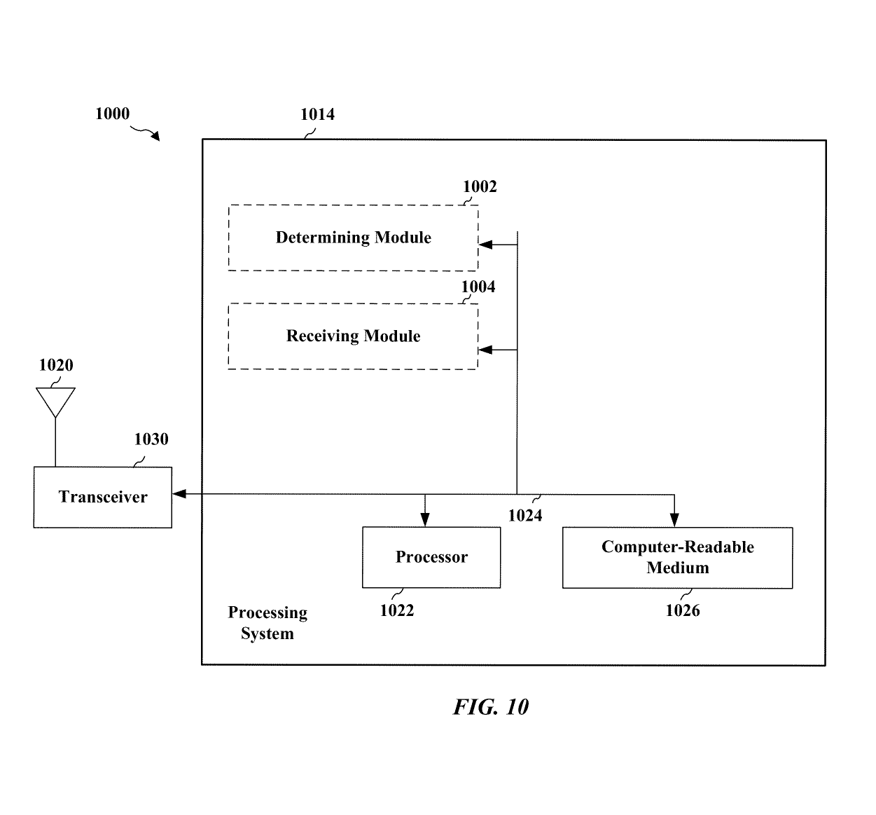

FIG. 10 is a diagram illustrating an example of a hardware implementation for an apparatus 1000 employing a processing system 1014. The processing system 1014 may be implemented with a bus architecture, represented generally by the bus 1024. The bus 1024 may include any number of interconnecting buses and bridges depending on the specific application of the processing system 1014 and the overall design constraints. The bus 1024 links together various circuits including one or more processors and/or hardware modules, represented by the processor 1022 the modules 1002, 1004 and the computer-readable medium 1026. The bus 1024 may also link various other circuits such as timing sources, peripherals, voltage regulators, and power management circuits, which are well known in the art, and therefore, will not be described any further.

The apparatus includes a processing system 1014 coupled to a transceiver 1030. The transceiver 1030 is coupled to one or more antennas 1020. The transceiver 1030 enables communicating with various other apparatus over a transmission medium. The processing system 1014 includes a processor 1022 coupled to a computer-readable medium 1026. The processor 1022 is responsible for general processing, including the execution of software stored on the computer-readable medium 1026. The software, when executed by the processor 1022, causes the processing system 1014 to perform the various functions described for any particular apparatus. The computer-readable medium 1026 may also be used for storing data that is manipulated by the processor 1022 when executing software.

The processing system 1014 includes a determining module 1002 for determining a configuration for a first group of subframes and a second group of subframes. The determining module 1002 may also determine a T/P value for the second group of subframes based at least in part on the received signal(s). The processing system 1014 also includes a receiving module 1004 for receiving a signal(s) that includes a T/P indicator. The modules may be software modules running in the processor 1022, resident/stored in the computer-readable medium 1026, one or more hardware modules coupled to the processor 1022, or some combination thereof. The processing system 1014 may be a component of the UE 550 and may include the memory 560, and/or the controller/processor 559.

In one configuration, an apparatus such as a UE 550 is configured for wireless communication including means for receiving and means for determining. In one configuration, the receiving means may be the antennas 552, the receiver 554, the receive processor 556, the controller/processor 559, the memory 560, receiving module 1004, and/or the processing system 1014 configured to perform the functions recited by the receiving means. Furthermore, in one configuration, the determining means may be the receive processor 556, the controller/processor 559, the memory 560, receiving module 1004, and/or the processing system 1014 configured to perform the functions recited by the receiving means. In another configuration, the aforementioned means may be a module or any apparatus configured to perform the functions recited by the aforementioned means.

In another configuration, an apparatus such as an eNodeB 510 is configured for wireless communication including means for indicating and means for transmitting. In one configuration, the indicating means and transmitting means may be the antennas 520, the transmitter 518, the transmit processor 516, the controller/processor 575, and the memory 576, configured to perform the functions recited by the indicating means and transmitting means. In another configuration, the aforementioned means may be a module or any apparatus configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication, comprising:
determining a first group of subframes;
determining a second group of subframes, the second group not overlapping the first group;
receiving at least one signal including a traffic to pilot ratio (T/P) indicator; and
determining a T/P value for the second group based at least in part on the at least one signal.

2. The method of claim 1, in which:
the first group of subframes comprises a first subset of subframes and a second subset of subframes;
the at least one signal indicates a first T/P value for the first subset and a second T/P value for the second subset; and
determining the T/P value for the second group comprises determining the T/P for the second group based at least in part on the first T/P value and the second T/P value.

3. The method of claim 2, in which the at least one signal includes a broadcast bitmap including T/P values for each group of subframes.

4. The method of claim 1, in which the at least one signal is a physical download control channel (PDCCH).

5. The method of claim 4, in which the at least one signal includes one transmit power control (TPC) bit to indicate the T/P value.

6. The method of claim 4, in which the at least one signal includes one hybrid automatic repeat request (HARQ) process identification bit to indicate the T/P value.

7. The method of claim 1, in which the at least one signal includes a cell radio network temporary identifier (CRNTI) to indicate the T/P value.

8. The method of claim 1, in which the at least one signal includes a control channel element (CCE) search space to indicate the T/P value.

9. The method of claim 1, in which the at least one signal is a radio resource control signal.

10. The method of claim 1, in which the at least one signal includes a modulation coding scheme (MCS) value to indicate the T/P value.

11. A method of wireless communication, comprising:
indicating a configuration for a first group of subframes;
transmitting at least one traffic to pilot ratio (T/P) value; and
transmitting at least one signal to associate the T/P value with at least one group of subframes.

12. The method of claim 11, further comprising indicating a configuration for a second group of subframes, the second group not overlapping the first group.

13. The method of claim 11, in which the at least one signal includes one or more of:
a transmit power control (TPC) bit to indicate the T/P value;
a hybrid automatic repeat request (HARQ) process identification bit to indicate the T/P value;
a cell radio network temporary identifier (CRNTI) to indicate the T/P value;
a control channel element (CCE) search space to indicate the T/P value;
a broadcast bitmap including T/P values for each group of subframes;
a radio resource control signal;
a modulation coding scheme (MCS) value to indicate the T/P value, or
a combination thereof.

14. An apparatus for wireless communication, the apparatus comprising:
means for determining a first group of subframes;
means for determining a second group of subframes, the second group not overlapping the first group;
means for receiving at least one signal including a traffic to pilot ratio (T/P) indicator; and
means for determining a T/P value for the second group based at least in part on the at least one signal.

15. A apparatus for wireless communication, the apparatus comprising:
means for indicating a configuration for a first group of subframes;
means for transmitting at least one traffic to pilot ratio (T/P) value; and
means for transmitting at least one signal to associate the T/P value with at least one group of subframes.

16. A computer program product for wireless communications, the computer program product comprising:
a non-transitory computer-readable medium having program code recorded thereon, the program code comprising:
program code to determine a first group of subframes;
program code to determine a second group of subframes, the second group not overlapping the first group;
program code to receive at least one signal including a traffic to pilot ratio (T/P) indicator; and
program code to determine a T/P value for the second group based at least in part on the at least one signal.

17. A computer program product for wireless communications, the computer program product comprising:
a non-transitory computer-readable medium having program code recorded thereon, the program code comprising:
program code to indicate a configuration for a first group of subframes;
program code to transmit at least one traffic to pilot ratio (T/P) value; and
program code to transmit at least one signal to associate the T/P value with at least one group of subframes.

18. An apparatus for wireless communications, comprising:
a memory; and
at least one processor coupled to the memory, the at least one processor being configured:
to determine a first group of subframes;
to determine a second group of subframes, the second group not overlapping the first group;
to receive at least one signal including a traffic to pilot ratio (T/P) indicator; and
to determine a T/P value for the second group based at least in part on the at least one signal.

19. The apparatus of claim 18, in which:
the first group of subframes comprises a first subset of subframes and a second subset of subframes; and
the at least one signal indicates a first T/P value for the first subset and a second T/P value for the second subset; and
in which the at least one processor is further configured to determine the T/P for the second group based at least in part on the first T/P value and the second T/P value.

20. The apparatus of claim 19, in which the at least one signal includes a broadcast bitmap including T/P values for each group of subframes.

21. The apparatus of claim 18, in which the at least one signal is a physical download control channel (PDCCH).

22. The apparatus of claim 21, in which the at least one signal includes one transmit power control (TPC) bit to indicate the T/P value.

23. The apparatus of claim 21, in which the at least one signal includes one hybrid automatic repeat request (HARQ) process identification bit to indicate the T/P value.

24. The apparatus of claim 18, in which the at least one signal includes a cell radio network temporary identifier (CRNTI) to indicate the T/P value.

25. The apparatus of claim 18, in which the at least one signal includes a control channel element (CCE) search space to indicate the T/P value.

26. The apparatus of claim 18, in which the at least one signal is a radio resource control signal.

27. The apparatus of claim 18, in which the at least one signal includes a modulation coding scheme (MCS) value to indicate the T/P value.

28. An apparatus for wireless communications, comprising:
a memory; and
at least one processor coupled to the memory, the at least one processor being configured:
to indicate a configuration for a first group of subframes;
to transmit at least one traffic to pilot ratio (T/P) value; and
to transmit at least one signal to associate the T/P value with at least one group of subframes.

29. The apparatus of claim 28, in which the at least one processor is further configured to indicate a configuration for a second group of subframes, the second group not overlapping the first group.

30. The apparatus of claim 28, in which the at least one signal includes one or more of:
a transmit power control (TPC) bit to indicate the T/P value;
a hybrid automatic repeat request (HARQ) process identification bit to indicate the T/P value;
a cell radio network temporary identifier (CRNTI) to indicate the T/P value;
a control channel element (CCE) search space to indicate the T/P value;
a broadcast bitmap including T/P values for each group of subframes;
a radio resource control signal;
a modulation coding scheme (MCS) value to indicate the T/P value, or
a combination thereof.
